(19) United States
(12) Patent Application Publication
(10) Pub. No.: US 2025/0285467 A1
(43) Pub. Date: Sep. 11, 2025

(54) DEEP LEARNING-BASED FACIAL RECOGNITION SYSTEM WITH PRIVACY-PRESERVING FEATURES

(71) Applicants: Bhaskar TRIPATHI, Patialia (IN); Senthilnathan CHIDAMBARANATHAN, Piscataway, NJ (US); Thangavel MURUGAN, Al Ain (AE); Shermin SHAMSUDHEEN, Jazan (SA); Bhraguram Thayyil Madhusudana PANICKER, Shinas (OM); Anne ANOOP, Jazan (SA); Nithya Rekha SIVAKUMAR, Riyadh (SA); Sreenivas Reddy SAGILI, Rochester, NY (US); Neelima GUNTUPALLI, Guntur (IN); Thiru Nirai Senthil SUBRAMANIAN, Neyveli (IN); Sangeetha SUBRAMANIAM, Trichy (IN); Baskar KANDASAMY, Trichy (IN)

(72) Inventors: Bhaskar TRIPATHI, Patialia (IN); Senthilnathan CHIDAMBARANATHAN, Piscataway, NJ (US); Thangavel MURUGAN, Al Ain (AE); Shermin SHAMSUDHEEN, Jazan (SA); Bhraguram Thayyil Madhusudana PANICKER, Shinas (OM); Anne ANOOP, Jazan (SA); Nithya Rekha SIVAKUMAR, Riyadh (SA); Sreenivas Reddy SAGILI, Rochester, NY (US); Neelima GUNTUPALLI, Guntur (IN); Thiru Nirai Senthil SUBRAMANIAN, Neyveli (IN); Sangeetha SUBRAMANIAM, Trichy (IN); Baskar KANDASAMY, Trichy (IN)

(21) Appl. No.: 19/214,023

(22) Filed: May 20, 2025

(51) Int. Cl. G06V 40/16; G06F 21/32; G06F 21/62; G06T 3/18; G06T 3/4007; G06T 5/20

(52) U.S. Cl. CPC G06V 40/172; G06F 21/32; G06F 21/6254; G06T 3/18; G06T 3/4007; G06T 5/20; G06V 40/169; G06V 40/171; G06T 2207/20032; G06T 2207/20084

(57) ABSTRACT

The present invention provides a facial recognition system using deep learning methodologies while integrating privacy-preserving capabilities. This system employs convolutional neural networks (CNNs) to extract and classify facial features, ensuring high accuracy in recognition tasks. Moreover, the system addresses privacy concerns by incorporating techniques such as facial feature encryption and anonymization, thereby enhancing user privacy and data security. This invention is applicable across various domains, including security, surveillance, access control, and personalized services, where facial recognition is utilized while preserving individual privacy.

### TECHNICAL FIELD

The present invention related to facial recognition systems, and in particularly, relates to Deep Learning-Based Facial Recognition System with Privacy-Preserving Features.

### BACKGROUND

Facial recognition technology has witnessed a transformative evolution in recent years, propelled by the rapid advancement of deep learning methodologies. The traditional methods of facial recognition, which relied on handcrafted features and shallow learning techniques, have been surpassed by the superior capabilities of deep learning architectures, particularly convolutional neural networks (CNNs). These CNNs excel in learning hierarchical representations of facial features from raw pixel data, enabling more accurate and robust recognition performance. The breakthroughs in deep learning have revolutionized various industries, including security, surveillance, access control, and personalized services, where facial recognition plays a pivotal role in identity verification and authentication processes.

However, alongside the remarkable progress in accuracy and efficiency, the widespread adoption of facial recognition systems has raised significant concerns regarding privacy violations and data security. As these systems proliferate across public and private domains, users increasingly express apprehensions about the potential misuse of their personal information. The ability of facial recognition systems to capture and process sensitive biometric data, such as facial images, raises legitimate privacy concerns regarding unauthorized access, surveillance, and profiling. Moreover, the vulnerability of centralized databases storing facial data to security breaches and hacking poses additional risks to individual privacy and data security.

In response to these challenges, researchers and industry practitioners have sought to develop facial recognition systems with built-in privacy-preserving features. These features aim to mitigate privacy risks associated with facial recognition technology while ensuring accurate and reliable performance. Privacy-preserving techniques such as encryption, anonymization, and decentralized processing have emerged as effective strategies to protect user privacy in facial recognition systems. Encryption techniques enable the secure storage and transmission of facial data by obfuscating sensitive information, thus preventing unauthorized access and interception. Anonymization techniques further enhance privacy protection by removing or obfuscating personally identifiable information from facial feature vectors, rendering them unlinkable to specific individuals. Decentralized processing strategies distribute facial recognition tasks across multiple nodes, limiting the exposure of sensitive data to individual entities and reducing the risk of privacy breaches.

Moreover, regulatory frameworks and standards have been proposed and implemented to govern the ethical and responsible deployment of facial recognition technology. These regulations aim to balance the benefits of facial recognition with the protection of individual privacy and civil liberties. Measures such as data minimization, purpose limitation, and transparency requirements are enforced to ensure that facial recognition systems collect and process data in a lawful and ethical manner. Additionally, efforts are underway to establish guidelines for the responsible use of facial recognition in law enforcement, public surveillance, and commercial applications, with a focus on accountability, fairness, and non-discrimination.

Despite these advancements and regulatory efforts, challenges persist in reconciling the objectives of accuracy and privacy in facial recognition systems. The trade-off between maximizing recognition performance and safeguarding user privacy remains a fundamental issue in the design and implementation of these systems. Striking the right balance between accuracy and privacy requires interdisciplinary collaboration among researchers, policymakers, industry stakeholders, and civil society organizations. Ethical considerations, human rights principles, and societal values must be integrated into the development and deployment of facial recognition technology to ensure its responsible and equitable use. To mitigate these concerns, there is a critical need for facial recognition systems that not only deliver accurate results but also prioritize user privacy. Privacy-preserving techniques such as encryption, anonymization, and decentralized processing can help address privacy risks associated with facial recognition systems. Integrating these techniques into a deep learning-based facial recognition system would ensure both accuracy and privacy, making it more acceptable and reliable for various applications.

### SUMMARY OF THE INVENTION

The present invention provides a deep learning-based facial recognition system with privacy-preserving features. The system comprises several modules designed to perform facial recognition tasks while safeguarding user privacy. These modules include an image preprocessing module, a feature extraction module utilizing CNNs, a classification module, and privacy-preserving techniques such as facial feature encryption, anonymization, and decentralized processing.

The image preprocessing module receives input facial images and performs tasks such as normalization, alignment, and noise reduction to enhance data quality. The feature extraction module utilizes CNN architectures optimized for facial feature extraction to extract high-dimensional feature vectors from preprocessed facial images. These feature vectors are then fed into the classification module, which employs various techniques for identity classification. Privacy-preserving techniques such as facial feature encryption and anonymization are applied to protect sensitive user data, ensuring that even if unauthorized access occurs, user privacy remains intact. Decentralized processing techniques may also be employed to distribute facial recognition tasks across multiple nodes, further enhancing privacy protection.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a facial recognition system in accordance with an embodiment of the present disclosure; and

FIG. 2 illustrates a flow chart of a method for facial recognition in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

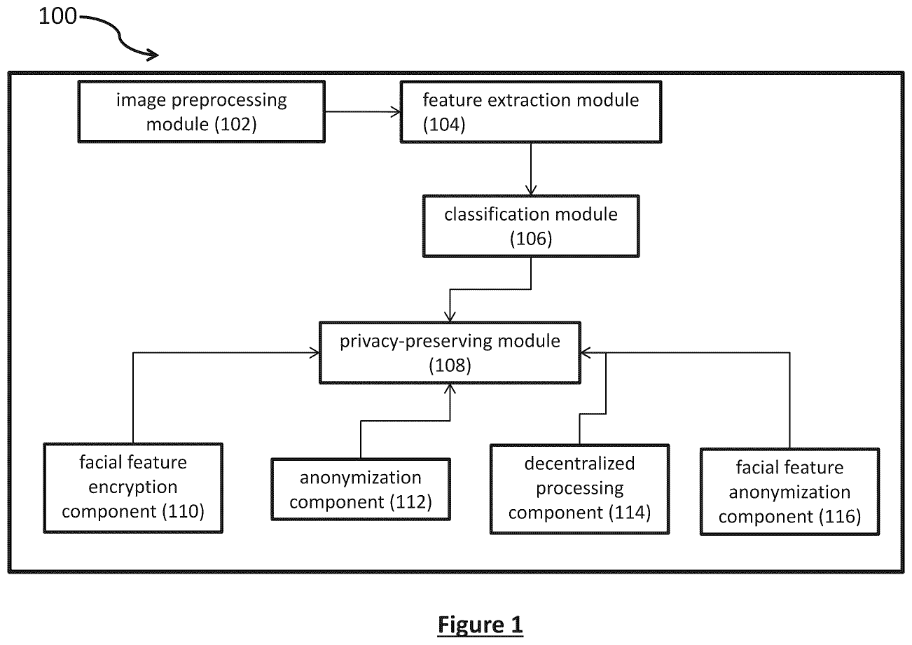

FIG. 1 illustrates a block diagram of a facial recognition system (100) in accordance with an embodiment of the present disclosure.

Referring to FIG. 1, the system (100) includes an image preprocessing module (102) configured to receive input facial images and perform normalization, alignment, and noise reduction tasks to enhance image quality and consistency.

In an embodiment, a feature extraction module (104) utilizes convolutional neural networks (CNNs) to extract high-dimensional feature vectors from preprocessed facial images, wherein said CNNs employ architectures optimized for facial feature extraction.

In an embodiment, a classification module (106) configured to receive extracted feature vectors and employ classification techniques for identity classification, wherein said classification techniques include softmax regression and support vector machines (SVMs).

In an embodiment, a privacy-preserving module (108) comprises: a facial feature encryption component (110) configured to encrypt facial feature vectors before storage or transmission, utilizing secure encryption techniques such as AES or RSA, and managing encryption keys securely to ensure authorized decryption; an anonymization component (112) configured to remove or obfuscate personally identifiable information from facial feature vectors, thereby enhancing privacy protection; and a decentralized processing component (114) configured to distribute facial recognition tasks across multiple nodes, preventing any single entity from accessing complete facial information and enhancing privacy.

In an embodiment, the normalization in the image preprocessing module (102) includes illumination normalization, geometric normalization, and contrast enhancement techniques to enhance image quality.

In an embodiment, the feature extraction module (104) utilizes a ResNet architecture comprising residual blocks to capture fine-grained facial features with increased depth and accuracy.

In an embodiment, the classification module (106) employs an ensemble learning technique, combining multiple classification techniques such as softmax regression, SVMs, and decision trees to enhance recognition accuracy and robustness.

In an embodiment, the privacy-preserving module (108) further comprises a facial feature anonymization component (116) configured to remove or obfuscate personally identifiable information based on predefined privacy policies or user preferences, thereby enhancing privacy protection.

In an embodiment, the feature extraction module (104) employs CNN architectures including VGGFace, ResNet, or Inception for facial feature extraction.

In an embodiment, the image preprocessing module implements illumination normalization by dynamically computing a per-region gamma correction curve based on local pixel intensity variance maps, wherein the geometric normalization uses a two-stage non-rigid alignment method that first detects 68 facial landmarks using a cascaded regression framework, followed by thin-plate spline warping constrained by learned facial shape priors to correct subtle deformations,

wherein noise reduction is performed by a hybrid noise suppression technique combining wavelet domain soft-thresholding with spatially adaptive Wiener filtering, thereby preserving critical facial micro-textures essential for downstream feature extraction.

In one embodiment, the image preprocessing module is configured to perform advanced illumination and geometric normalization, as well as noise reduction, to prepare facial images for high-fidelity feature extraction. Illumination normalization is achieved by dynamically computing a per-region gamma correction curve, wherein each curve is adapted based on a local pixel intensity variance map, thereby compensating for uneven lighting conditions across facial regions. Geometric normalization is performed using a two-stage non-rigid alignment procedure, wherein a first stage involves the detection of 68 predefined facial landmarks using a cascaded regression framework that refines landmark positions through multiple iterative stages, and a second stage applies thin-plate spline (TPS) warping constrained by learned facial shape priors, such that the warping accounts for both global misalignments and localized deformations, including expressions and pose variations. Noise reduction is conducted using a hybrid suppression approach that combines wavelet domain soft-thresholding, which targets high-frequency noise components while preserving sharp features, with spatially adaptive Wiener filtering, which estimates local noise characteristics to suppress low-frequency and spatially correlated noise, thereby maintaining critical facial micro-textures essential for subsequent high-resolution feature extraction and recognition tasks.

In an embodiment, the feature extraction module employs a ResNet-based CNN architecture augmented with squeeze-and-excitation (SE) blocks inserted after each residual block to recalibrate channel-wise feature responses dynamically, wherein the ResNet architecture is modified by incorporating a multi-scale receptive field module utilizing dilated convolutions at varying dilation rates (1, 2, 4) within residual blocks to capture both global and local facial features simultaneously, wherein the CNN model parameters are optimized using a compound loss function combining angular softmax loss and center loss to simultaneously improve inter-class separability and intra-class compactness of facial embeddings.

In one embodiment, the feature extraction module comprises a modified convolutional neural network (CNN) architecture based on ResNet, wherein each residual block is augmented with a squeeze-and-excitation (SE) module configured to dynamically recalibrate channel-wise feature responses by modeling interdependencies between feature channels using global average pooling followed by a gating mechanism with learnable parameters. The base ResNet architecture is further modified to incorporate a multi-scale receptive field module within selected residual blocks, wherein the convolutional layers utilize dilated convolutions with varying dilation rates of 1, 2, and 4 in parallel paths, such that both fine-grained local features and broader contextual facial patterns are captured concurrently, thereby enhancing robustness to variations in pose, expression, and occlusion. The resulting feature maps are fused and passed through subsequent layers for embedding generation. The CNN model parameters are trained using a compound loss function comprising an angular softmax loss, which enforces angular margin constraints to maximize inter-class separability by projecting features onto a hypersphere, and a center loss, which penalizes the Euclidean distance between feature vectors and their corresponding class centers in the embedding space to minimize intra-class variance. This joint optimization strategy ensures that the extracted facial embeddings exhibit both discriminative power across identities and compactness within individual identity clusters.

In an embodiment, the classification module applies a hierarchical ensemble classification process, wherein an initial softmax regression layer filters out low-confidence identities below a dynamically computed threshold based on entropy of the softmax output distribution, wherein filtered feature vectors are subsequently classified by an SVM ensemble trained with a one-vs-one strategy and employing a Mahalanobis distance-based kernel function parameterized by class covariance matrices to enhance discriminative power, wherein a decision tree classifier trained with gradient boosting is used as a final verification layer, performing adaptive rejection of ambiguous classifications based on posterior probability confidence intervals.

In one embodiment, the classification module implements a hierarchical ensemble classification framework designed to enhance robustness and accuracy in identity verification. Initially, a softmax regression layer is applied to the extracted facial feature vectors, wherein the output probability distribution is analyzed using Shannon entropy, and a dynamically computed confidence threshold is used to filter out feature vectors corresponding to low-confidence identity predictions, thereby reducing false positives in subsequent stages. The remaining high-confidence feature vectors are passed to a second-stage ensemble of support vector machines (SVMs) trained using a one-vs-one strategy, wherein each binary classifier employs a Mahalanobis distance-based kernel function, the parameters of which are derived from the class-specific covariance matrices to improve class separation and account for feature distribution anisotropy. The outputs of the SVM ensemble are then subject to a third verification stage involving a decision tree classifier trained with gradient boosting, wherein the model adaptively performs rejection of uncertain classifications by evaluating the posterior probability confidence intervals of candidate class assignments. This hierarchical classification pipeline synergistically combines probabilistic filtering, margin-based separation, and decision-theoretic verification to achieve high accuracy and resilience against outlier or ambiguous inputs.

In an embodiment, the image preprocessing module performs illumination normalization by segmenting the received facial image into overlapping blocks of 16 by 16 pixels, wherein for each block, the mean and standard deviation of pixel intensity values are calculated and used to linearly transform pixel intensities to a predefined normalized range, wherein the transformation is adjusted based on a locally computed contrast gain factor that is dynamically derived from the ratio of the block's intensity variance to a global image variance computed over the entire facial image, and wherein the overlapping blocks are merged by applying a weighted blending technique with Gaussian weighting centered at block midpoints to ensure smooth transitions between adjacent blocks, thereby preventing visible seams or artifacts in the normalized image, wherein the entire normalization operation is executed within a bounded latency of 50 milliseconds for real-time facial image processing.

In one embodiment, the image preprocessing module executes illumination normalization by dividing the input facial image into overlapping blocks of 16×16 pixels. For each block, the local mean and standard deviation of pixel intensity values are computed, and a linear transformation is applied to map the block's pixel intensities to a predefined normalized intensity range. This linear normalization is adaptively modulated by a contrast gain factor, which is dynamically calculated for each block as the ratio of the local intensity variance to the global variance of the entire facial image, thereby preserving local contrast while maintaining global illumination consistency. The overlapping blocks are subsequently merged using a weighted blending strategy that employs a Gaussian kernel centered at each block's midpoint, ensuring smooth transitions across block boundaries and preventing visible seams or artifacts in the composite normalized image. The entire normalization pipeline is computationally optimized to execute within a latency constraint of 50 milliseconds, thereby enabling real-time preprocessing suitable for time-sensitive facial recognition applications.

In an embodiment, the geometric normalization within the image preprocessing module comprises detecting a set of predefined facial landmarks including but not limited to bilateral eye centers, nose tip, and mouth corners by applying a two-stage detection technique, wherein the first stage employs a coarse detection based on gradient-based feature extraction using Sobel operators to identify candidate landmark regions, and the second stage refines these landmark positions by applying a cascade of regression trees trained on manually annotated datasets to reduce localization error below 2 pixels, wherein the coordinates of the refined landmarks are then used to compute a similarity transformation matrix constrained to preserve the original facial aspect ratio within a tolerance of ±3%, and wherein this matrix is applied to warp the input facial image using bilinear interpolation, thereby aligning the detected landmarks to a canonical facial template prior to feature extraction.

In one embodiment, the geometric normalization component of the image preprocessing module is configured to standardize facial geometry through a multi-stage landmark detection and transformation process. A set of predefined facial landmarks—including but not limited to bilateral eye centers, nasal tip, and bilateral mouth corners—is detected using a two-stage technique. In the first stage, candidate landmark regions are identified through gradient-based feature extraction utilizing Sobel operators to emphasize edge intensity patterns corresponding to prominent facial structures. In the second stage, the coarse landmark estimates are refined via a cascaded regression framework comprising multiple stages of regression trees trained on a diverse set of manually annotated facial images, wherein the model minimizes landmark localization error to within 2 pixels in image space. Following refinement, the coordinates of the detected landmarks are used to compute a similarity transformation matrix constrained to preserve the original facial aspect ratio within a tolerance of ±3%, thereby maintaining the geometric integrity of the input facial image. This transformation matrix is subsequently applied to the input image using bilinear interpolation, resulting in a geometrically normalized output that aligns the landmark configuration to a predefined canonical facial template. This process ensures consistency in facial alignment prior to feature extraction, enhancing the accuracy and robustness of downstream recognition tasks.

In an embodiment, the noise reduction operation in the image preprocessing module comprises a sequential two-stage filtering process, wherein the first stage applies an adaptive median filter that scans the facial image using a sliding window of size 5 by 5 pixels to detect and replace pixels identified as impulsive noise based on intensity variance exceeding a threshold of 15%, and wherein the second stage performs a wavelet-domain denoising operation where the facial image is decomposed into multi-resolution sub-bands using a discrete wavelet transform with three decomposition levels, the high-frequency coefficients at each level are subjected to soft-thresholding with a threshold calculated as 0.8 times the median absolute deviation of the coefficients, and wherein the denoised image is reconstructed via inverse wavelet transform to maintain facial edge sharpness while significantly reducing noise artifacts.

In one embodiment, the noise reduction operation in the image preprocessing module is configured as a sequential two-stage filtering pipeline designed to preserve critical facial structures while attenuating various forms of noise. In the first stage, an adaptive median filter is employed, wherein a sliding window of 5×5 pixels traverses the facial image, and for each windowed region, the local intensity variance is computed. Pixels exhibiting intensity deviations exceeding 15% of the local variance are classified as impulsive noise and are replaced with the median value of the non-noisy neighboring pixels, thereby suppressing salt-and-pepper noise while preserving edge integrity. In the second stage, the output of the median filter is subjected to wavelet-domain denoising. The filtered image is decomposed into multi-resolution frequency sub-bands using a three-level discrete wavelet transform (DWT), wherein high-frequency detail coefficients—corresponding to horizontal, vertical, and diagonal components—are individually processed via soft-thresholding. The soft-thresholding threshold is dynamically computed for each sub-band as 0.8 times the median absolute deviation (MAD) of its coefficients, thereby achieving noise suppression tailored to the statistical properties of each frequency component. The denoised image is then reconstructed using an inverse DWT, resulting in a final image with significantly reduced noise artifacts and preserved micro-textural details critical for downstream facial feature analysis and recognition.

In an embodiment, the feature extraction module comprises a plurality of stacked residual blocks, each residual block containing two convolutional layers with 3×3 kernels, each convolutional layer followed sequentially by batch normalization and rectified linear unit activation, wherein each residual block receives an input tensor comprising N feature channels and produces an output tensor with the same N channels, and wherein the input tensor is added element-wise to the output of the second convolutional layer via a skip connection to facilitate gradient propagation during training, wherein the total depth of the feature extraction module includes 34 such residual blocks, thereby enabling extraction of fine-grained hierarchical facial features while maintaining computational efficiency for real-time operation.

In one embodiment, the feature extraction module is implemented as a deep residual network comprising a plurality of stacked residual blocks configured for high-fidelity extraction of hierarchical facial representations. Each residual block includes two sequential convolutional layers, each employing 3×3 convolutional kernels with stride 1 and padding 1 to preserve spatial resolution. Each convolutional layer is immediately followed by batch normalization to stabilize internal covariate shifts and a rectified linear unit (ReLU) activation function to introduce non-linearity. The input tensor to each residual block comprises N feature channels and is passed through the two convolutional layers in sequence. The output of the second convolutional layer is added element-wise to the original input tensor via a skip connection, facilitating residual learning and enabling stable backpropagation of gradients through the network during training. This architectural design mitigates the vanishing gradient problem commonly observed in deep networks. The complete feature extraction module comprises 34 such residual blocks, resulting in a deep architecture that effectively captures multi-scale and fine-grained facial features while maintaining computational efficiency suitable for real-time execution on embedded or resource-constrained platforms.

In an embodiment, the feature extraction module performs multi-scale convolutional feature capture by applying three parallel convolution operations on the same input feature map, wherein the first convolution uses a 1×1 kernel to capture fine-grained local features, the second convolution uses a 3×3 kernel to extract intermediate spatial patterns, and the third convolution uses a 5×5 kernel to capture broader contextual facial features, wherein the outputs of these three parallel convolutions are concatenated channel-wise to form a composite feature map, which is then passed through a 1×1 convolutional bottleneck layer that reduces the concatenated feature map's dimensionality by 50% to minimize computational load, wherein the relative contribution of each kernel size is adaptively weighted by computing channel-wise attention scores based on the exponential moving average of activation magnitudes over the last 100 processed images, thereby dynamically emphasizing feature scales most relevant under varying lighting and pose conditions.

In one embodiment, the feature extraction module implements a multi-scale convolutional feature capture mechanism configured to extract discriminative facial features across varying spatial resolutions. Specifically, three parallel convolutional branches operate on a shared input feature map. The first branch employs a 1×1 convolutional kernel to capture fine-grained, localized texture details. The second branch applies a 3×3 convolution to extract intermediate-range spatial dependencies, while the third branch utilizes a 5×5 convolutional kernel to capture broader contextual information such as pose and illumination variation. The output feature maps from the three convolutional branches are concatenated along the channel dimension to form a unified, multi-scale composite feature map. This composite is then processed by a 1×1 convolutional bottleneck layer configured to reduce the channel dimensionality by approximately 50%, thereby decreasing the computational complexity without significantly compromising feature richness. Furthermore, the system dynamically modulates the contribution of each convolutional branch using a channel-wise attention mechanism. Specifically, an exponential moving average (EMA) of the activation magnitudes is computed for each channel over the most recent 100 input images. These EMA values are normalized and used as adaptive attention weights, which re-scale the channel outputs from each convolutional branch prior to concatenation, thereby emphasizing feature scales most relevant under dynamically changing lighting, pose, and occlusion conditions

In an embodiment, the classification module aggregates classification results from multiple base classifiers by computing a weighted sum of the softmax probability outputs for each identity class, wherein the weighting coefficients for each classifier are updated every 500 facial recognition cycles by calculating an exponentially weighted moving average of the classifier's recent accuracy on a held-out validation set, wherein the aggregated classification confidence is further refined by calculating the entropy of the combined class probability distribution, and wherein if the entropy exceeds a predefined threshold indicating uncertainty, a secondary classification procedure is invoked which reprocesses the input facial image through the feature extraction module with modified preprocessing parameters selected via a reinforcement learning technique trained to maximize classification confidence under uncertainty.

In one embodiment, the classification module performs dynamic ensemble aggregation of classification results from a plurality of base classifiers by computing a weighted sum of the softmax probability outputs associated with each identity class. The weighting coefficients assigned to each classifier are updated adaptively every 500 facial recognition cycles, wherein each coefficient is computed as an exponentially weighted moving average (EWMA) of the classifier's recent classification accuracy measured on a continuously updated held-out validation set. This temporal weighting scheme ensures that the influence of each classifier in the ensemble reflects its current reliability under operational conditions. The aggregated classification output is further refined by computing the Shannon entropy of the combined probability distribution over all identity classes. If the entropy exceeds a predefined uncertainty threshold—indicating a diffuse or low-confidence prediction—a secondary classification pathway is activated. In this secondary pathway, the input facial image is reprocessed through the feature extraction module, but with modified preprocessing parameters selected by a reinforcement learning (RL) agent. The RL agent is trained to optimize a reward function that favors preprocessing configurations which maximize the post-reprocessing classification confidence, thereby improving prediction certainty in ambiguous cases. This architecture enables the system to adaptively recover from uncertain classification outcomes by exploiting a learned strategy for input transformation conditioned on entropy signals.

In an embodiment, the facial feature encryption component encrypts the extracted feature vectors by first segmenting the feature vector into fixed-size blocks of 128 bits, wherein each block is independently encrypted using a session-specific symmetric key generated by a hardware security module compliant with Federal Information Processing Standard (FIPS) 140-2 Level 3, wherein the session key is itself encrypted and stored using a multi-party key management system involving threshold secret sharing across at least five geographically separated nodes, and wherein the encrypted feature blocks are stored in a distributed ledger that records metadata including timestamp, encryption key identifiers, and access control lists to prevent unauthorized retrieval.

In an embodiment, the facial feature encryption component encrypts the extracted feature vectors by segmenting each feature vector into fixed-size blocks of 128 bits, wherein each block is independently encrypted using a session-specific symmetric key generated by a hardware security module (HSM) compliant with Federal Information Processing Standard (FIPS) 140-2Level 3. The session key is further encrypted and securely stored using a multi-party key management system implementing threshold secret sharing across at least five geographically separated nodes to ensure robust key protection and fault tolerance. The encrypted feature blocks are then stored in a distributed ledger configured to record associated metadata including precise timestamps, encryption key identifiers, and access control lists, thereby preventing unauthorized retrieval and ensuring auditability and traceability of all encryption operations.

In an embodiment, the anonymization component operates by first identifying sensitive feature dimensions within the extracted facial feature vectors using a predefined mapping derived from user-configurable privacy policies, wherein these sensitive feature dimensions are obfuscated by applying a randomized perturbation generated via a cryptographically secure pseudo-random number generator seeded with a device-specific unique identifier, wherein the magnitude of perturbation is adaptively controlled based on a privacy-utility tradeoff function that balances the decrease in re-identification risk against the preservation of classification accuracy, and wherein the anonymized feature vectors are verified for compliance with privacy constraints prior to storage or transmission.

In an embodiment, the anonymization component identifies sensitive feature dimensions within the extracted facial feature vectors based on a predefined mapping configured according to user-specified privacy policies. The component then applies randomized perturbations to these sensitive dimensions, wherein the perturbations are generated using a cryptographically secure pseudo-random number generator seeded with a device-specific unique identifier to ensure reproducibility and security. The magnitude of each perturbation is adaptively adjusted by evaluating a privacy-utility tradeoff function, which dynamically balances reduction of re-identification risk against preservation of classification accuracy. Prior to storage or transmission, the anonymized feature vectors undergo verification to ensure compliance with established privacy constraints.

In an embodiment, the decentralized processing component partitions the facial recognition workflow into four discrete stages comprising image preprocessing, feature extraction, classification, and feature encryption, wherein each stage is assigned to separate computational nodes in a peer-to-peer network such that the input to each node contains only the minimal data necessary for the assigned stage and no node receives complete facial image data, wherein the inter-node communication utilizes ephemeral keys generated through a Diffie-Hellman key exchange mechanism performed per recognition session, and wherein the decentralized component continuously monitors processing latency and node trustworthiness scores, dynamically reassigning stages to maintain system throughput and privacy guarantees.

In an embodiment, the decentralized processing component partitions the facial recognition workflow into four discrete stages comprising image preprocessing, feature extraction, classification, and feature encryption, wherein each stage is executed on separate computational nodes within a peer-to-peer network architecture such that each node receives only the minimal input data necessary for its assigned processing stage, thereby preventing any single node from accessing complete facial image data. Inter-node communication is secured by ephemeral cryptographic keys generated via a Diffie-Hellman key exchange protocol established uniquely for each recognition session to ensure forward secrecy. The decentralized processing component further continuously monitors system performance metrics, including processing latency and node trustworthiness scores derived from historical behavior and anomaly detection algorithms, and dynamically reassigns workflow stages among nodes to optimize throughput while preserving privacy and security guarantees.

In an embodiment, the image preprocessing module includes an illumination normalization subroutine that adaptively calibrates the contrast enhancement factor for each incoming facial image by analyzing the global histogram skewness and kurtosis metrics and selecting an enhancement curve from a predefined library of piecewise linear transformations, wherein the selected curve is parameterized by a brightness gain limited to a maximum of 1.2 times to avoid oversaturation, and wherein the normalized image is then subjected to a Gaussian sharpening filter with a kernel size of 5×5 and standard deviation of 1.0 to enhance high-frequency facial details critical for downstream feature extraction.

In an embodiment, the image preprocessing module comprises an illumination normalization subroutine configured to adaptively calibrate a contrast enhancement factor for each received facial image by analyzing global histogram skewness and kurtosis metrics, wherein based on the analyzed metrics, the subroutine selects an enhancement curve from a predefined library of piecewise linear transformations, the selected curve being parameterized by a brightness gain limited to a maximum of 1.2 times to prevent oversaturation of image regions. The illumination-normalized image is subsequently processed using a Gaussian sharpening filter characterized by a kernel size of 5×5 and a standard deviation of 1.0, thereby enhancing high-frequency facial features critical for downstream feature extraction.

In an embodiment, the feature extraction module implements an early-exit mechanism by inserting confidence estimation units after every fourth residual block, wherein the confidence estimation unit computes a posterior probability distribution over known identities based on intermediate feature maps and triggers an early output of the feature vector if the highest posterior probability exceeds a threshold of 0.95 and the entropy of the distribution is below 0.1, thereby reducing computational load by bypassing deeper layers when sufficient classification confidence is achieved at earlier network stages.

In an embodiment, the feature extraction module incorporates an early-exit mechanism by embedding confidence estimation units subsequent to every fourth residual block within the network architecture, wherein each confidence estimation unit computes a posterior probability distribution over the set of known identities based on the intermediate feature maps. The unit triggers an early output of the feature vector when the highest posterior probability surpasses a predetermined threshold of 0.95 and the entropy of the posterior distribution is below 0.1,thereby enabling computational efficiency by bypassing the processing of deeper network layers when sufficient classification confidence is attained at earlier stages

In an embodiment, the classification module maintains a sliding temporal window of five consecutive frames of the same subject, wherein for each frame the identity classification output and confidence score are recorded, and wherein a temporal consistency check is performed by calculating the weighted average of the classification confidences, weighted by an exponentially decaying function with a half-life of two frames, wherein a significant drop in temporal consistency below 80% confidence triggers a request for reacquisition and reprocessing of facial images with adjusted camera parameters to compensate for motion blur or occlusions, and wherein the facial feature encryption component implements an authenticated encryption scheme by combining symmetric encryption of feature vector blocks with message authentication codes generated using a keyed-hash function, wherein the authentication tags are appended to each encrypted block and verified upon decryption to ensure data integrity and detect tampering attempts, and wherein the encryption keys are rotated after every 1000 facial recognition events and securely archived with audit logging to prevent replay attacks.

In an embodiment, the classification module maintains a sliding temporal window encompassing five consecutive frames of a detected subject, wherein for each frame, the identity classification output and associated confidence score are recorded, and wherein a temporal consistency check is conducted by computing a weighted average of the classification confidences, the weights being derived from an exponentially decaying function with a half-life of two frames. A temporal consistency value falling below a predefined threshold of 80% confidence triggers a reacquisition request, prompting reprocessing of facial images with dynamically adjusted camera parameters to mitigate effects of motion blur or occlusion. Concurrently, the facial feature encryption component employs an authenticated encryption scheme combining symmetric encryption of feature vector blocks with message authentication codes generated via a keyed-hash function, wherein authentication tags are appended to each encrypted block and verified during decryption to ensure data integrity and detect tampering. The encryption keys are systematically rotated after every 1000 recognition events and securely archived with audit logging to prevent replay attacks.

In an embodiment, the anonymization component uses a differential privacy mechanism to perturb sensitive dimensions of the facial feature vector by adding Laplace-distributed noise with scale parameter dynamically calibrated based on the current threat model, wherein the magnitude of noise addition is adjusted to maintain a privacy budget epsilon of 0.5 per recognition event while preserving classification accuracy above 95%, and wherein the component provides configurable user interface options to modify privacy budget parameters in compliance with applicable data protection regulations.

In an embodiment, the anonymization component implements a differential privacy mechanism by injecting Laplace-distributed noise into selected sensitive dimensions of the facial feature vector, wherein the noise scale parameter is dynamically calibrated in accordance with a real-time threat model to optimize privacy-utility trade-offs. The magnitude of noise addition is adaptively controlled to maintain a privacy budget ε of 0.5 per recognition event while ensuring that classification accuracy remains above 95%. Furthermore, the component provides a configurable user interface that enables end-users or administrators to adjust privacy budget parameters, thereby facilitating compliance with relevant data protection regulations and organizational privacy policies.

In an embodiment, the decentralized processing component enforces data minimization by encrypting intermediate outputs at each processing stage with ephemeral keys unique to each node, wherein each node stores only encrypted data fragments and performs homomorphic operations allowing feature extraction and classification on encrypted data without decrypting, and wherein an orchestrator node coordinates task distribution, key management, and aggregation of classification results using secure multi-party computation protocols ensuring end-to-end data confidentiality.

In an embodiment, the decentralized processing component enforces data minimization by encrypting intermediate outputs at each processing stage using ephemeral encryption keys unique to each computational node, wherein each node stores exclusively encrypted data fragments and performs homomorphic operations enabling feature extraction and classification directly on encrypted data without requiring decryption. An orchestrator node coordinates task distribution, manages key lifecycle, and aggregates classification results employing secure multi-party computation protocols, thereby ensuring end-to-end data confidentiality throughout the facial recognition workflow.

In an embodiment, the image preprocessing module integrates a contrast enhancement step that adaptively adjusts the gamma correction parameter based on the facial image's measured average luminance level, wherein the gamma value is computed by applying a sigmoid mapping function constrained between 0.8 and 1.2 to prevent excessive darkening or brightening, and wherein the gamma-corrected image is then converted into a color space optimized for skin tone segmentation prior to geometric normalization, wherein the feature extraction module employs a channel pruning strategy by periodically analyzing the channel-wise activation statistics over a batch of 500 processed images, wherein channels exhibiting average activation magnitudes below 0.05 are marked for pruning and removed from subsequent network iterations, thereby reducing computational complexity and memory footprint without significant degradation in recognition accuracy, and wherein the pruning schedule is dynamically adjusted based on monitored system latency to maintain real-time processing constraints.

In an embodiment, the image preprocessing module integrates a contrast enhancement step that adaptively adjusts the gamma correction parameter based on the measured average luminance level of the facial image, wherein the gamma value is computed via a sigmoid mapping function constrained within a range of 0.8 to 1.2 to avoid excessive darkening or brightening effects. The gamma-corrected image is subsequently transformed into a color space optimized for skin tone segmentation prior to the application of geometric normalization. Furthermore, the feature extraction module implements a channel pruning strategy by periodically evaluating channel-wise activation statistics over batches of 500 processed images, wherein channels exhibiting average activation magnitudes below 0.05 are flagged for pruning and eliminated from subsequent network iterations. This pruning approach reduces computational complexity and memory usage while preserving recognition accuracy, and the pruning schedule is dynamically modulated in response to monitored system latency to ensure compliance with real-time processing requirements.

In an embodiment, the classification module utilizes a hierarchical identity matching approach by first performing a coarse classification into broad demographic clusters such as age group and gender using a shallow neural network, followed by fine-grained identity classification within the identified cluster using a deep convolutional classifier, wherein the hierarchical approach reduces the overall search space for identity matching and accelerates classification by at least 30% compared to flat classification models, and wherein the facial feature encryption component supports key revocation and re-encryption by maintaining a versioned key registry accessible through an authenticated API, wherein upon key compromise, all feature vectors encrypted with the compromised key are re-encrypted using a newly generated key by applying a batch decryption and re-encryption procedure facilitated by hardware acceleration, and wherein all re-encryption events are logged with timestamps and cryptographic signatures to enable forensic auditing, and wherein the anonymization component incorporates a user-controlled masking functionality that allows selective suppression of feature vector dimensions associated with identifiable facial attributes such as eye color, skin tone, or facial hair, wherein the masking is achieved by setting the respective feature values to zero and re-normalizing the feature vector using L2 normalization to maintain classifier compatibility, and wherein the masking configuration is enforced through a secure user authentication process to prevent unauthorized changes.

In an embodiment, the classification module employs a hierarchical identity matching approach by initially performing a coarse classification into broad demographic clusters, including but not limited to age group and gender, using a shallow neural network, followed by fine-grained identity classification within the identified cluster via a deep convolutional classifier. This hierarchical scheme reduces the overall search space for identity matching, resulting in an acceleration of classification performance by at least 30% compared to conventional flat classification models. Concurrently, the facial feature encryption component supports key revocation and re-encryption by maintaining a versioned key registry accessible through an authenticated application programming interface (API). Upon detection of a key compromise, all feature vectors encrypted with the compromised key are batch decrypted and subsequently re-encrypted using a newly generated key via a hardware-accelerated procedure. All such re-encryption events are logged with precise timestamps and cryptographic signatures to facilitate forensic auditing. Additionally, the anonymization component incorporates a user-controlled masking functionality that enables selective suppression of feature vector dimensions corresponding to identifiable facial attributes, including but not limited to eye color, skin tone, or facial hair. Masking is implemented by zeroing the respective feature values and subsequently re-normalizing the feature vector using L2 normalization to preserve compatibility with downstream classifiers. The masking configuration is securely enforced through a user authentication process to prevent unauthorized modifications.

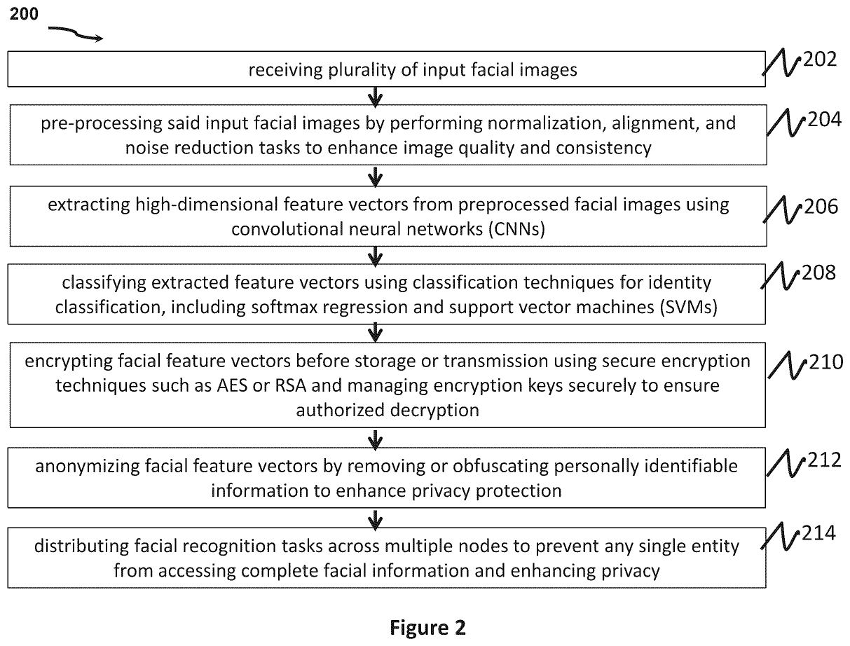

FIG. 2 illustrates a flow chart of a method (200) for facial recognition in accordance with an embodiment of the present disclosure.

Referring to FIG. 2, the method (200) includes multiple steps for facial recognition, which are described below.

At step (202), the method (200) includes receiving plurality of input facial images.

At step (204), the method (200) includes pre-processing said input facial images by performing normalization, alignment, and noise reduction tasks to enhance image quality and consistency.

At step (206), the method (200) includes extracting high-dimensional feature vectors from preprocessed facial images using convolutional neural networks (CNNs), wherein said CNNs employ architectures optimized for facial feature extraction.

At step (208), the method (200) includes classifying extracted feature vectors using classification techniques for identity classification, including softmax regression and support vector machines (SVMs).

At step (210), the method (200) includes encrypting facial feature vectors before storage or transmission using secure encryption techniques such as AES or RSA and managing encryption keys securely to ensure authorized decryption.

At step (212), the method (200) includes anonymizing facial feature vectors by removing or obfuscating personally identifiable information to enhance privacy protection.

At step (214), the method (200) includes distributing facial recognition tasks across multiple nodes to prevent any single entity from accessing complete facial information and enhancing privacy.

In an embodiment, said preprocessing tasks include illumination normalization, geometric normalization, and noise reduction to enhance image quality.

In an embodiment, the normalization step in the image preprocessing includes applying histogram equalization to adjust image contrast and brightness, thereby enhancing image quality and consistency, and wherein the feature extraction step utilizes transfer learning techniques, pre-training a CNN model on a large dataset of generic images before fine-tuning it on a smaller dataset of facial images to improve feature extraction performance.

In an embodiment, the classification step employs an ensemble of classifiers, combining the predictions of multiple classifiers using techniques such as weighted averaging or voting to enhance recognition accuracy and reliability, and wherein the privacy-preserving step further comprises generating cryptographic keys using secure key generation techniques, such as RSA or elliptic curve cryptography, to ensure robust encryption and decryption of facial feature vectors.

In the image preprocessing stage, input facial images undergo normalization, alignment, and noise reduction to improve quality and consistency. The feature extraction module utilizes CNNs to extract high-dimensional feature vectors from preprocessed facial images. These feature vectors capture discriminative facial characteristics essential for recognition tasks. Subsequently, the classification module employs techniques such as softmax regression or support vector machines (SVMs) for identity classification based on the extracted features.

Privacy-preserving techniques are integrated into the system to enhance user privacy. Facial feature encryption is applied before storing or transmitting facial feature vectors, ensuring sensitive information remains obscured. Anonymization techniques may further obfuscate personally identifiable information from facial feature vectors, enhancing privacy protection. In scenarios where centralized processing poses privacy risks, decentralized processing techniques may be employed to distribute facial recognition tasks across multiple nodes, preventing any single entity from accessing complete facial information.

Following preprocessing, the system enters the realm of feature extraction, where deep learning techniques reign supreme. Convolutional neural networks (CNNs), revered for their ability to learn complex hierarchical representations from raw data, take center stage in this phase. Using architectures specifically optimized for facial feature extraction, such as VGGFace, ResNet, or Inception, the CNNs embark on the task of deciphering the intricate nuances of facial structures. Trained on extensive datasets containing a diverse array of facial images, these networks meticulously analyze pixel-level information to distill it into high-dimensional feature vectors.

With feature extraction complete, the system transitions into the realm of classification, where the extracted feature vectors undergo scrutiny to discern the identities they represent. Here, an array of classification techniques come into play, each endowed with its own set of strengths and intricacies. Softmax regression, a probabilistic classifier capable of generating probability distributions over multiple classes, and support vector machines (SVMs), revered for their ability to delineate decision boundaries in high-dimensional space, stand out as prominent contenders in this arena. Trained on labeled datasets containing feature vectors associated with specific individuals, these classifiers meticulously scrutinize the extracted features, discerning subtle patterns and nuances that facilitate accurate identity classification.

However, the quest for accurate recognition is not the sole objective of the system; it is equally committed to upholding the principles of privacy and data security. To this end, a suite of privacy-preserving mechanisms is seamlessly integrated into the system, ensuring that the recognition process unfolds within a framework of robust privacy safeguards. At the forefront of these mechanisms lies facial feature encryption, a technique designed to cloak sensitive information within the feature vectors. By using encryption techniques such as AES or RSA, the system obscures the details encapsulated within the vectors, rendering them indecipherable to prying eyes. Access to the encrypted data is tightly controlled, with encryption keys meticulously managed to ensure that only authorized entities possess the requisite permissions for decryption.

Complementing facial feature encryption is the concept of anonymization, a practice aimed at further fortifying user privacy by obscuring personally identifiable information within the feature vectors. Through techniques such as data masking or obfuscation, the system meticulously scrubs the vectors of any traces of sensitive information, thereby safeguarding the anonymity of the individuals they represent. This ensures that even in the event of unauthorized access, the risk of identifying specific individuals remains minimal, preserving the sanctity of user privacy.

In parallel with these privacy-preserving measures, the system also embraces the concept of decentralized processing, a strategy designed to distribute computational tasks across multiple nodes. By dispersing the computational workload, this invention mitigates the risk associated with centralized data processing, where a single entity wields unfettered access to datasets. Instead, facial recognition tasks are partitioned and distributed across disparate nodes, each operating independently and contributing to the collective goal of recognition. This decentralized architecture serves as a bulwark against privacy breaches, as no single node possesses the complete dataset necessary to compromise the privacy of individuals.

The drawings and the forgoing description give examples of embodiments. Those skilled in the art will appreciate that one or more of the described elements may well be combined into a single functional clement. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A facial recognition system comprising:
an image preprocessing module configured to receive input facial images and perform normalization, alignment, and noise reduction tasks to enhance image quality and consistency;
a feature extraction module utilizing convolutional neural networks (CNNs) to extract high-dimensional feature vectors from preprocessed facial images, wherein said CNNs employ architectures optimized for facial feature extraction;
a classification module configured to receive extracted feature vectors and employ classification techniques for identity classification, wherein said classification techniques include softmax regression and support vector machines (SVMs);
a privacy-preserving module comprising:
a facial feature encryption component configured to encrypt facial feature vectors before storage or transmission, utilizing secure encryption techniques such as AES or RSA, and managing encryption keys securely to ensure authorized decryption;
an anonymization component configured to remove or obfuscate personally identifiable information from facial feature vectors, thereby enhancing privacy protection; and
a decentralized processing component configured to distribute facial recognition tasks across multiple nodes, preventing any single entity from accessing complete facial information and enhancing privacy, wherein the normalization in the image preprocessing module includes illumination normalization, geometric normalization, and contrast enhancement techniques to enhance image quality, wherein the feature extraction module utilizes a ResNet architecture comprising residual blocks to capture fine-grained facial features with increased depth and accuracy, wherein the classification module employs an ensemble learning technique, combining multiple classification techniques such as softmax regression, SVMs, and decision trees to enhance recognition accuracy and robustness; and wherein the privacy-preserving module further comprises a facial feature anonymization component configured to remove or obfuscate personally identifiable information based on predefined privacy policies or user preferences, thereby enhancing privacy protection, and wherein said feature extraction module employs CNN architectures including VGGFace, ResNet, or Inception for facial feature extraction, wherein the image preprocessing module implements illumination normalization by dynamically computing a per-region gamma correction curve based on local pixel intensity variance maps, wherein the geometric normalization uses a two-stage non-rigid alignment method that first detects 68 facial landmarks using a cascaded regression framework, followed by thin-plate spline warping constrained by learned facial shape priors to correct subtle deformations,
wherein noise reduction is performed by a hybrid noise suppression technique combining wavelet domain soft-thresholding with spatially adaptive Wiener filtering, thereby preserving critical facial micro-textures essential for downstream feature extraction, wherein the feature extraction module employs a ResNet-based CNN architecture augmented with squeeze-and-excitation (SE) blocks inserted after each residual block to recalibrate channel-wise feature responses dynamically, wherein the ResNet architecture is modified by incorporating a multi-scale receptive field module utilizing dilated convolutions at varying dilation rates (1, 2, 4) within residual blocks to capture both global and local facial features simultaneously, wherein the CNN model parameters are optimized using a compound loss function combining angular softmax loss and center loss to simultaneously improve inter-class separability and intra-class compactness of facial embeddings, and wherein the classification module applies a hierarchical ensemble classification process, wherein an initial softmax regression layer filters out low-confidence identities below a dynamically computed threshold based on entropy of the softmax output distribution, wherein filtered feature vectors are subsequently classified by an SVM ensemble trained with a one-vs-one strategy and employing a Mahalanobis distance-based kernel function parameterized by class covariance matrices to enhance discriminative power, wherein a decision tree classifier trained with gradient boosting is used as a final verification layer, performing adaptive rejection of ambiguous classifications based on posterior probability confidence intervals.

2. The facial recognition system of claim 1, wherein the image preprocessing module performs illumination normalization by segmenting the received facial image into overlapping blocks of 16 by 16 pixels, wherein for each block, the mean and standard deviation of pixel intensity values are calculated and used to linearly transform pixel intensities to a predefined normalized range, wherein the transformation is adjusted based on a locally computed contrast gain factor that is dynamically derived from the ratio of the block's intensity variance to a global image variance computed over the entire facial image, and wherein the overlapping blocks are merged by applying a weighted blending technique with Gaussian weighting centered at block midpoints to ensure smooth transitions between adjacent blocks, thereby preventing visible seams or artifacts in the normalized image, wherein the entire normalization operation is executed within a bounded latency of 50 milliseconds for real-time facial image processing.

3. The facial recognition system of claim 1, wherein the geometric normalization within the image preprocessing module comprises detecting a set of predefined facial landmarks including but not limited to bilateral eye centers, nose tip, and mouth corners by applying a two-stage detection technique, wherein the first stage employs a coarse detection based on gradient-based feature extraction using Sobel operators to identify candidate landmark regions, and the second stage refines these landmark positions by applying a cascade of regression trees trained on manually annotated datasets to reduce localization error below 2 pixels, wherein the coordinates of the refined landmarks are then used to compute a similarity transformation matrix constrained to preserve the original facial aspect ratio within a tolerance of ±3%, and wherein this matrix is applied to warp the input facial image using bilinear interpolation, thereby aligning the detected landmarks to a canonical facial template prior to feature extraction.

4. The facial recognition system of claim 1, wherein the noise reduction operation in the image preprocessing module comprises a sequential two-stage filtering process, wherein the first stage applies an adaptive median filter that scans the facial image using a sliding window of size 5 by 5 pixels to detect and replace pixels identified as impulsive noise based on intensity variance exceeding a threshold of 15%, and wherein the second stage performs a wavelet-domain denoising operation where the facial image is decomposed into multi-resolution sub-bands using a discrete wavelet transform with three decomposition levels, the high-frequency coefficients at each level are subjected to soft-thresholding with a threshold calculated as 0.8 times the median absolute deviation of the coefficients, and wherein the denoised image is reconstructed via inverse wavelet transform to maintain facial edge sharpness while significantly reducing noise artifacts.

5. The facial recognition system of claim 1, wherein the feature extraction module comprises a plurality of stacked residual blocks, each residual block containing two convolutional layers with 3×3 kernels, each convolutional layer followed sequentially by batch normalization and rectified linear unit activation, wherein each residual block receives an input tensor comprising N feature channels and produces an output tensor with the same N channels, and wherein the input tensor is added element-wise to the output of the second convolutional layer via a skip connection to facilitate gradient propagation during training, wherein the total depth of the feature extraction module includes 34 such residual blocks, thereby enabling extraction of fine-grained hierarchical facial features while maintaining computational efficiency for real-time operation.

6. The facial recognition system of claim 1, wherein the feature extraction module performs multi-scale convolutional feature capture by applying three parallel convolution operations on the same input feature map, wherein the first convolution uses a 1×1 kernel to capture fine-grained local features, the second convolution uses a 3×3 kernel to extract intermediate spatial patterns, and the third convolution uses a 5×5 kernel to capture broader contextual facial features, wherein the outputs of these three parallel convolutions are concatenated channel-wise to form a composite feature map, which is then passed through a 1×1 convolutional bottleneck layer that reduces the concatenated feature map's dimensionality by 50% to minimize computational load, wherein the relative contribution of each kernel size is adaptively weighted by computing channel-wise attention scores based on the exponential moving average of activation magnitudes over the last 100 processed images, thereby dynamically emphasizing feature scales most relevant under varying lighting and pose conditions.

7. The facial recognition system of claim 1, wherein the classification module aggregates classification results from multiple base classifiers by computing a weighted sum of the softmax probability outputs for each identity class, wherein the weighting coefficients for each classifier are updated every 500 facial recognition cycles by calculating an exponentially weighted moving average of the classifier's recent accuracy on a held-out validation set, wherein the aggregated classification confidence is further refined by calculating the entropy of the combined class probability distribution, and wherein if the entropy exceeds a predefined threshold indicating uncertainty, a secondary classification procedure is invoked which reprocesses the input facial image through the feature extraction module with modified preprocessing parameters selected via a reinforcement learning technique trained to maximize classification confidence under uncertainty.

8. The facial recognition system of claim 1, wherein the facial feature encryption component encrypts the extracted feature vectors by first segmenting the feature vector into fixed-size blocks of 128 bits, wherein each block is independently encrypted using a session-specific symmetric key generated by a hardware security module compliant with Federal Information Processing Standard (FIPS) 140-2 Level 3, wherein the session key is itself encrypted and stored using a multi-party key management system involving threshold secret sharing across at least five geographically separated nodes, and wherein the encrypted feature blocks are stored in a distributed ledger that records metadata including timestamp, encryption key identifiers, and access control lists to prevent unauthorized retrieval.

9. The facial recognition system of claim 1, wherein the anonymization component operates by first identifying sensitive feature dimensions within the extracted facial feature vectors using a predefined mapping derived from user-configurable privacy policies, wherein these sensitive feature dimensions are obfuscated by applying a randomized perturbation generated via a cryptographically secure pseudo-random number generator seeded with a device-specific unique identifier, wherein the magnitude of perturbation is adaptively controlled based on a privacy-utility tradeoff function that balances the decrease in re-identification risk against the preservation of classification accuracy, and wherein the anonymized feature vectors are verified for compliance with privacy constraints prior to storage or transmission.

10. The facial recognition system of claim 1, wherein the decentralized processing component partitions the facial recognition workflow into four discrete stages comprising image preprocessing, feature extraction, classification, and feature encryption, wherein each stage is assigned to separate computational nodes in a peer-to-peer network such that the input to each node contains only the minimal data necessary for the assigned stage and no node receives complete facial image data, wherein the inter-node communication utilizes ephemeral keys generated through a Diffie-Hellman key exchange mechanism performed per recognition session, and wherein the decentralized component continuously monitors processing latency and node trustworthiness scores, dynamically reassigning stages to maintain system throughput and privacy guarantees.

11. The facial recognition system of claim 1, wherein the image preprocessing module includes an illumination normalization subroutine that adaptively calibrates the contrast enhancement factor for each incoming facial image by analyzing the global histogram skewness and kurtosis metrics and selecting an enhancement curve from a predefined library of piecewise linear transformations, wherein the selected curve is parameterized by a brightness gain limited to a maximum of 1.2 times to avoid oversaturation, and wherein the normalized image is then subjected to a Gaussian sharpening filter with a kernel size of 5x5 and standard deviation of 1.0 to enhance high-frequency facial details critical for downstream feature extraction.

12. The facial recognition system of claim 1, wherein the feature extraction module implements an early-exit mechanism by inserting confidence estimation units after every fourth residual block, wherein the confidence estimation unit computes a posterior probability distribution over known identities based on intermediate feature maps and triggers an early output of the feature vector if the highest posterior probability exceeds a threshold of 0.95 and the entropy of the distribution is below 0.1, thereby reducing computational load by bypassing deeper layers when sufficient classification confidence is achieved at earlier network stages.

13. The facial recognition system of claim 1, wherein the classification module maintains a sliding temporal window of five consecutive frames of the same subject, wherein for each frame the identity classification output and confidence score are recorded, and wherein a temporal consistency check is performed by calculating the weighted average of the classification confidences, weighted by an exponentially decaying function with a half-life of two frames, wherein a significant drop in temporal consistency below 80% confidence triggers a request for reacquisition and reprocessing of facial images with adjusted camera parameters to compensate for motion blur or occlusions, and wherein the facial feature encryption component implements an authenticated encryption scheme by combining symmetric encryption of feature vector blocks with message authentication codes generated using a keyed-hash function, wherein the authentication tags are appended to each encrypted block and verified upon decryption to ensure data integrity and detect tampering attempts, and wherein the encryption keys are rotated after every 1000 facial recognition events and securely archived with audit logging to prevent replay attacks.

14. The facial recognition system of claim 1, wherein the anonymization component uses a differential privacy mechanism to perturb sensitive dimensions of the facial feature vector by adding Laplace-distributed noise with scale parameter dynamically calibrated based on the current threat model, wherein the magnitude of noise addition is adjusted to maintain a privacy budget epsilon of 0.5 per recognition event while preserving classification accuracy above 95%, and wherein the component provides configurable user interface options to modify privacy budget parameters in compliance with applicable data protection regulations.

15. The facial recognition system of claim 1, wherein the decentralized processing component enforces data minimization by encrypting intermediate outputs at each processing stage with ephemeral keys unique to each node, wherein each node stores only encrypted data fragments and performs homomorphic operations allowing feature extraction and classification on encrypted data without decrypting, and wherein an orchestrator node coordinates task distribution, key management, and aggregation of classification results using secure multi-party computation protocols ensuring end-to-end data confidentiality.

16. The facial recognition system of claim 1, wherein the image preprocessing module integrates a contrast enhancement step that adaptively adjusts the gamma correction parameter based on the facial image's measured average luminance level, wherein the gamma value is computed by applying a sigmoid mapping function constrained between 0.8 and 1.2 to prevent excessive darkening or brightening, and wherein the gamma-corrected image is then converted into a color space optimized for skin tone segmentation prior to geometric normalization, wherein the feature extraction module employs a channel pruning strategy by periodically analyzing the channel-wise activation statistics over a batch of 500 processed images, wherein channels exhibiting average activation magnitudes below 0.05 are marked for pruning and removed from subsequent network iterations, thereby reducing computational complexity and memory footprint without significant degradation in recognition accuracy, and wherein the pruning schedule is dynamically adjusted based on monitored system latency to maintain real-time processing constraints.

17. The facial recognition system of claim 1, wherein the classification module utilizes a hierarchical identity matching approach by first performing a coarse classification into broad demographic clusters such as age group and gender using a shallow neural network, followed by fine-grained identity classification within the identified cluster using a deep convolutional classifier, wherein the hierarchical approach reduces the overall search space for identity matching and accelerates classification by at least 30% compared to flat classification models, and wherein the facial feature encryption component supports key revocation and re-encryption by maintaining a versioned key registry accessible through an authenticated API, wherein upon key compromise, all feature vectors encrypted with the compromised key are re-encrypted using a newly generated key by applying a batch decryption and re-encryption procedure facilitated by hardware acceleration, and wherein all re-encryption events are logged with timestamps and cryptographic signatures to enable forensic auditing, and wherein the anonymization component incorporates a user-controlled masking functionality that allows selective suppression of feature vector dimensions associated with identifiable facial attributes such as eye color, skin tone, or facial hair, wherein the masking is achieved by setting the respective feature values to zero and re-normalizing the feature vector using L2normalization to maintain classifier compatibility, and wherein the masking configuration is enforced through a secure user authentication process to prevent unauthorized changes.
